(19) United States
(12) Patent Application Publication
(10) Pub. No.: US 2026/0236665 A1
(43) Pub. Date: Aug. 13, 2026

(54) Electronic Apparatus That Supports Korean Character Input Using Roman Letters and the Operating Method Thereof

(71) Applicant: Sang-Tae Kim, Cheongju-si (KR)

(72) Inventor: Sang-Tae Kim, Cheongju-si (KR)

(21) Appl. No.: 19/260,673

(22) Filed: Jul. 7, 2025

(30) Foreign Application Priority Data
Sep. 11, 2024 (KR) 10-2024-0123698

(51) Int. Cl. G06F 40/129; G06F 40/205; G06F 40/253; G06F 40/30

(52) U.S. Cl. CPC G06F 40/129; G06F 40/205; G06F 40/253; G06F 40/30

(57) ABSTRACT

An electronic apparatus and method convert Romanized Korean input into Hangul. The system maps input to syllables using a phonetic database and phonological rules. A combinational engine ranks candidates with similarity metrics and neural models. A BERT-based interface enhances accuracy for non-native users and supports real-time conversion in educational contexts.

### BACKGROUND OF THE INVENTION

Korean language input on electronic devices traditionally relies on dedicated keyboard layouts, such as the 2-set and 3-set Hangul keyboards. While effective for native speakers, these layouts are often inaccessible and unintuitive for non-native users, particularly those unfamiliar with the structural composition of Hangul or lacking access to physical Korean keyboards.

Although Romanized input methods exist, most rely on static transliteration rules and fixed character mappings. Such systems fail to capture the variability and fluidity of real-world language use. Common mobile input platforms, including Gboard and various IMEs, generally do not handle typographical errors, phonological ambiguity, slang, or emoticon-linked expressions. Furthermore, real-time feedback in these systems is often limited or absent, resulting in user frustration and inaccurate output.

Compounding these limitations, the Korean language exhibits phonological rules that produce surface-level transformations not represented in orthographic spelling. For example, “ [symbol] ” is pronounced as “ [symbol] ” due to palatalization, “ [symbol] ” becomes “ [symbol] ” through aspiration, and “ [symbol] ” is realized as “ [symbol] ” via nasal assimilation. These pronunciation-driven shifts pose significant challenges for learners and non-native speakers, who often input based on auditory perception rather than standardized forms. Conventional transliteration systems are ill-equipped to interpret such transformations accurately.

To address these challenges, the present invention introduces an adaptive and multi-layered Korean input framework that integrates: (1) phonological transformation rules, (2) combinational Roman-to-Hangul phoneme decomposition logic, (3) similarity evaluation algorithms such as Longest Common Subsequence (LCS) and acoustic phoneme distance models, and (4) a context-aware post-processing module utilizing a deep learning language model, such as BERT.

The system dynamically generates and ranks multiple Hangul candidates including both exact and phonologically plausible variants-based on phonotactic constraints, frequency statistics, and contextual fit. Users interactively confirm selections via a real-time query interface. The system is designed to interpret ambiguous input cases, such as “dachida” mapping to either “ [symbol] ” or “ [symbol] ”, by leveraging user feedback and similarity scoring.

In addition, the system may incorporate optional text-to-speech (TTS) functionality to audibly render the finalized Korean output, thereby improving accessibility for visually impaired users and enhancing usability in mobile or voice-controlled environments.

Globally, most users lack access to Hangul-specific input devices and are more familiar with Roman alphabet keyboards. This discrepancy presents a significant barrier to digital communication and Korean language acquisition. By using the Roman alphabet as a universal intermediary, the invention lowers the threshold for Korean input and bridges cross-linguistic and technological divides.

Accordingly, there exists a growing need for a robust, intelligent, and context-sensitive Korean character input system that accommodates diverse Romanized inputs, resolves phonological and semantic ambiguity, and supports real-time interactive feedback. The present invention addresses this need through a comprehensive architecture that unifies phoneme mapping, user-adaptive candidate expansion, semantic correction, and multi-modal output, providing an accurate, accessible, and globally scalable Korean input solution.

### SUMMARY OF THE INVENTION

The present invention provides a context-aware, phonologically adaptive, and user-interactive system for inputting Korean characters using Romanized letters. It is designed for users who lack access to Hangul-specific keyboards and are more familiar with the Roman alphabet, offering an intuitive interface that operates across desktop, mobile, and voice-based environments.

Unlike conventional input methods based on static transliteration rules or fixed dictionaries, the invention employs a combinational phoneme mapping engine that dynamically interprets Romanized input in real time. This engine handles both standard Roman-to-Hangul correspondences and diverse phonological transformations-including palatalization, aspiration, nasal assimilation, batchim-triggered tensing, compound onset alternation, and liquid variation-allowing the system to reflect actual Korean pronunciation rather than orthographic spelling.

If an exact mapping is unavailable, the system applies a phonological similarity evaluation algorithm, such as Longest Common Subsequence (LCS) or embedding-based phoneme distance metrics, to generate and rank plausible Hangul candidates. Rankings are determined using a composite scoring model incorporating pronunciation alignment, corpus-based frequency, contextual fit, and historical user behavior. A real-time query interface displays the top-ranked suggestions, enabling interactive selection, correction, and adaptation.

Once the user confirms a candidate, the syllable is rendered into the composition field. Upon phrase or sentence completion, a transformer-based language model (e.g., BERT) refines the output by correcting grammatical, semantic, and stylistic errors. This post-processing enables resolution of homophones, sentence-level disambiguation, and learner-driven inconsistencies that phonetic matching alone cannot resolve.

Additional features of the system include:
Multi-mapping support: A single Roman input (e.g., “k”) may correspond to multiple phonemes (“ [symbol] ”, “ [symbol] ”); the engine evaluates all contextually valid mappings.
Phoneme-aware correction: Non-standard, auditory, or learner-specific variations (e.g., “silla” for “ [symbol] ”) are interpreted through contextualized phonological rules.
Edge case handling: The system recognizes and adapts to slang (“jjenda”), emotive expressions (“ [symbol] ”), non-canonical batchim forms (“ [symbol] ”), and expressive patterns through an extended rule repository.
User-adaptive ranking: Frequent selections, feedback, and correction history are continuously learned to optimize future candidate prioritization.
Optional multimodal output: A text-to-speech engine may render the final Korean sentence as audio for accessibility and voice-based applications.

By integrating symbolic rule-based mapping, statistical candidate ranking, contextual semantic modeling, and user-driven learning, the invention bridges the gap between phonetic intuition and accurate Korean orthographic composition-empowering diverse users to input fluent, contextually precise Hangul from Roman letters.

### BRIEF DESCRIPTION OF THE DRAWINGS

FIG. 1 illustrates the overall system architecture for Romanized Korean character input. The system comprises five main modules:
an Input Acquisition Module that captures sequential Roman input,
a Combinational Mapping and Similarity Matching Module that generates Hangul candidates using phoneme rules and phonetic similarity,
a Candidate Ranking Engine that prioritizes outputs based on similarity metrics (e.g., LCS), frequency statistics, and user feedback,
a Query Interface Module for displaying candidates in real time and receiving user selection, and
a Context-Aware Post-Processing Unit utilizing a language model (e.g., BERT) to refine outputs based on sentence-level context.

FIG. 2 is a system flowchart that depicts the Roman-to-Hangul conversion pipeline. The flow includes capturing user input, generating multiple Hangul candidates using a phoneme mapping table, evaluating similarity using LCS and optionally neural embeddings, re-ranking candidates, contextual re-evaluation, and user-guided confirmation.

FIG. 3 provides a graphical representation of the user interface (UI). The UI dynamically displays candidate Hangul characters as the user types Roman letters, and allows users to select, correct, or confirm candidates in real time through interactive elements.

FIG. 4 illustrates the Similarity-Based Correction Engine. This module evaluates phonetic proximity between user input and dictionary forms using an LCS algorithm and, optionally, neural phonetic embeddings. The system tolerates common misspellings, inconsistent romanizations, and user-specific input errors.

FIG. 5 shows the Contextual Post-Processing Module powered by a transformer-based language model (e.g., BERT). It refines candidate sequences after initial Hangul generation by evaluating grammar, syntax, register, and semantic coherence, and disambiguates otherwise indistinguishable forms.

FIG. 6 depicts various edge-case scenarios handled by the system, including:
morphophonemic complexity (e.g., “balpda”→“ [symbol] ”),
slang or regionalisms (e.g., “jjenda”→“ [symbol] ”),
emotive symbols and mimicry (e.g., “ [symbol] ”, “ [symbol] ”), and
phonetic transcriptions based on auditory perception rather than orthographic accuracy.

FIG. 7 visualizes a representative Phoneme Mapping Table. It demonstrates how Romanized inputs (e.g., “k”) can correspond to multiple Hangul graphemes (“ [symbol] ”, “ [symbol] ”) depending on phonological context. The table includes IPA notations, variant mappings, and serves as a reference point for the system's rule-driven conversion process.

FIG. 8 illustrates a disambiguation scenario involving nonstandard Romanized input (e.g., “gukppap”) and outlines how the system resolves ambiguities through phonological similarity analysis, contextual inference, and frequency-based candidate ranking.

FIG. 9 presents representative phonological transformation rules employed by the system. Examples include:
nasal assimilation (“ [symbol] ”→[ [symbol] ]→“Jongno”),
palatalization (“ [symbol] ”→[ [symbol] ]→“gachi”),
aspiration (“ [symbol] ”→[ [symbol] ]→“joko”),
consonant insertion/elision (“ [symbol] ”→“ [symbol] ”→“Hangnyeoul”), and
tensed consonant reduction (“ [symbol] ”→“saetbyeol”).

FIG. 10 expands upon transformation rules specifically triggered by final consonants (batchim). These include:
palatalization from batchim “E”/“⊏” before high front vowels (“ [symbol] ”→“ [symbol] ”→“bachi”),
aspiration induced by suffixes (“ [symbol] ”→“ [symbol] ”→“dachida”),
tensing after cluster-final batchim (“ [symbol] ”→“ [symbol] ”→“gukppap”), and
liquid alternation based on phonotactic position (“ [symbol] ”→“ [symbol] ”→“silla”).

Such rules are applied dynamically during candidate evaluation and contextual ranking.

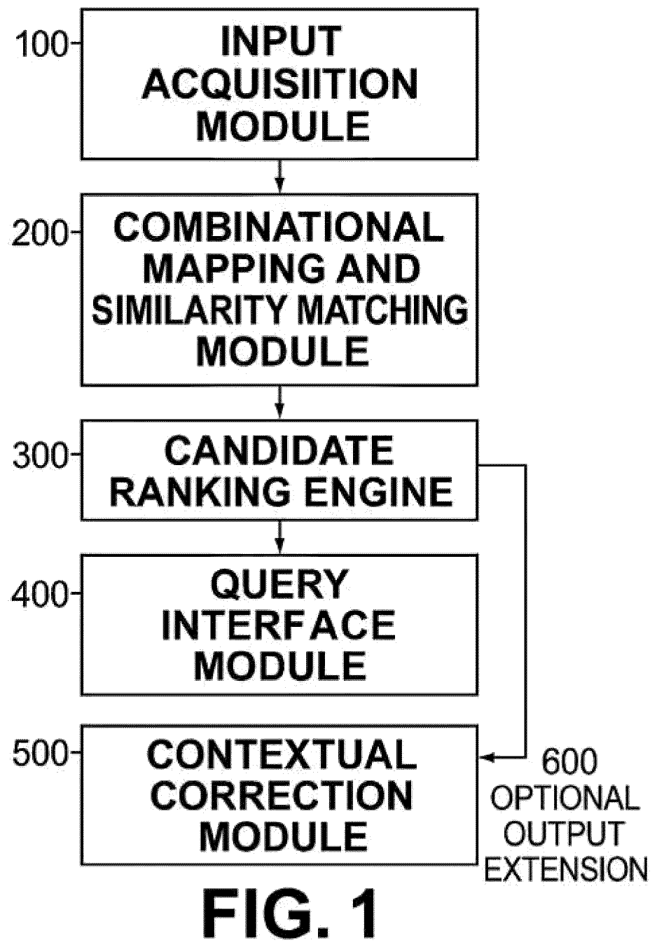

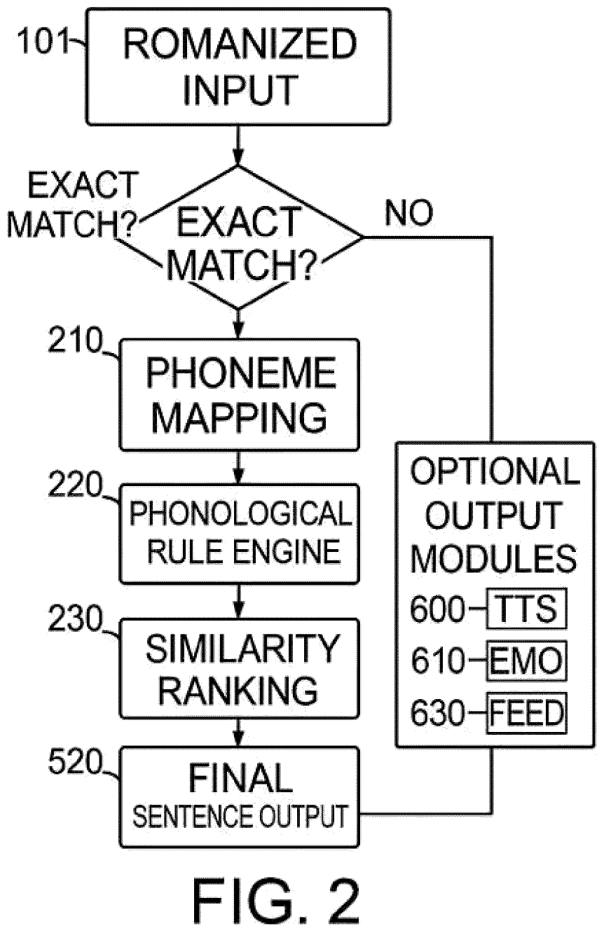

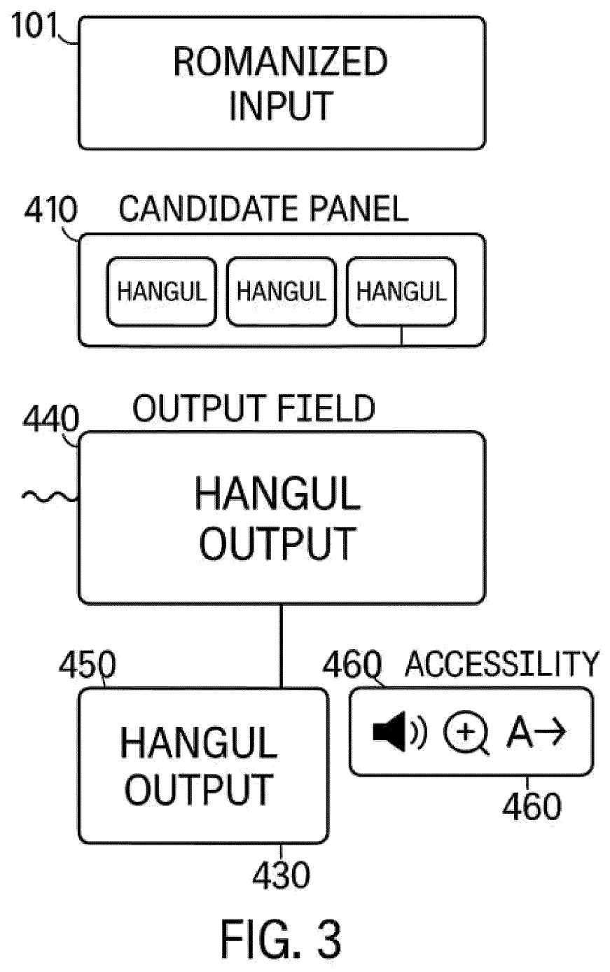

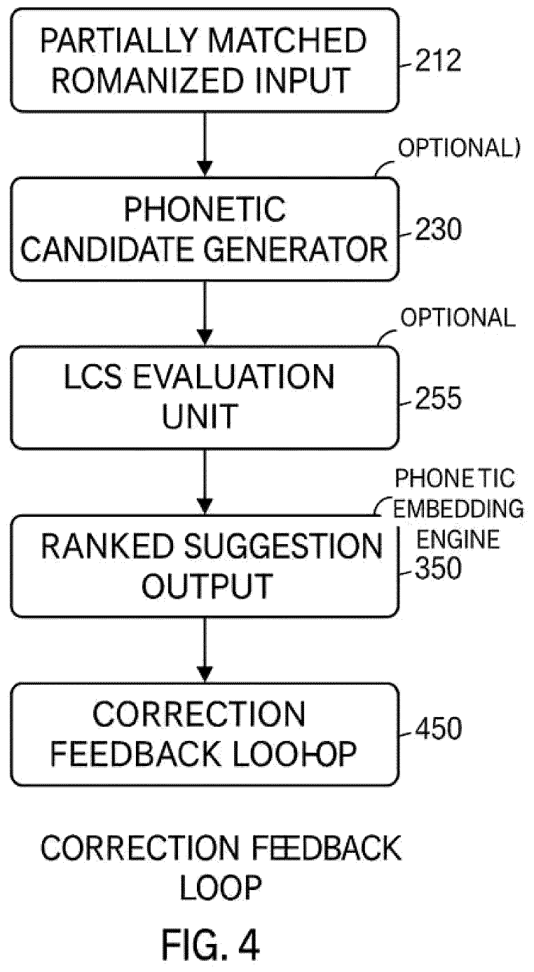

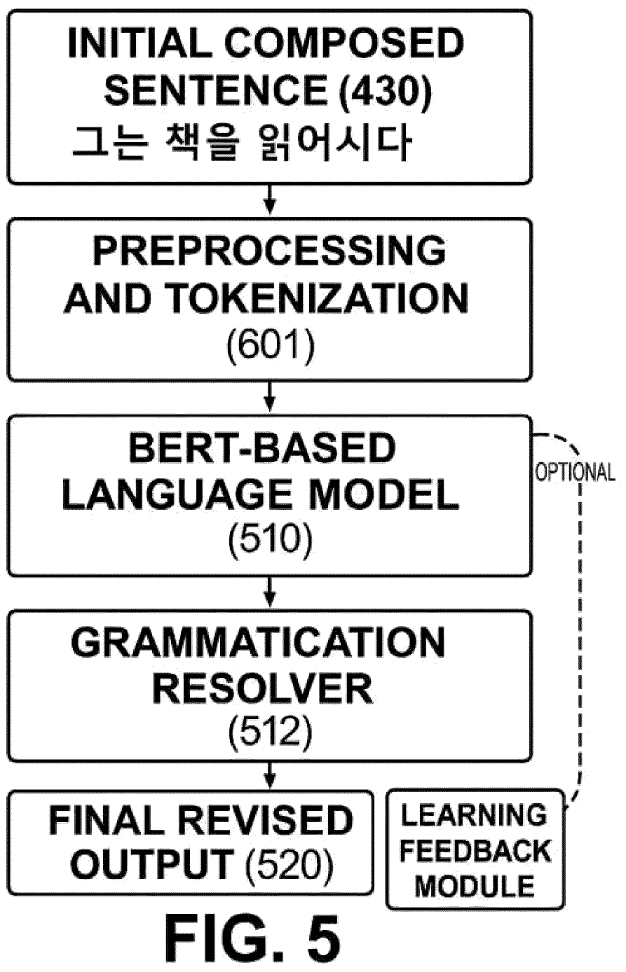

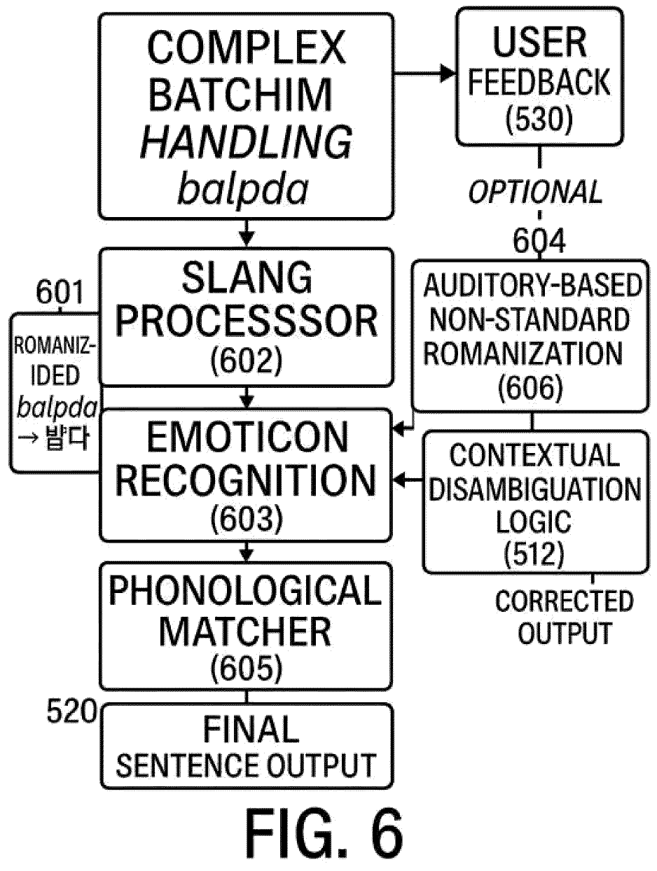

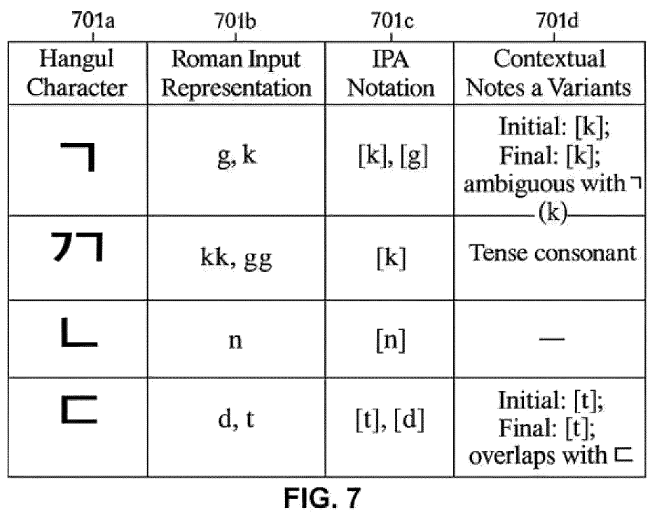

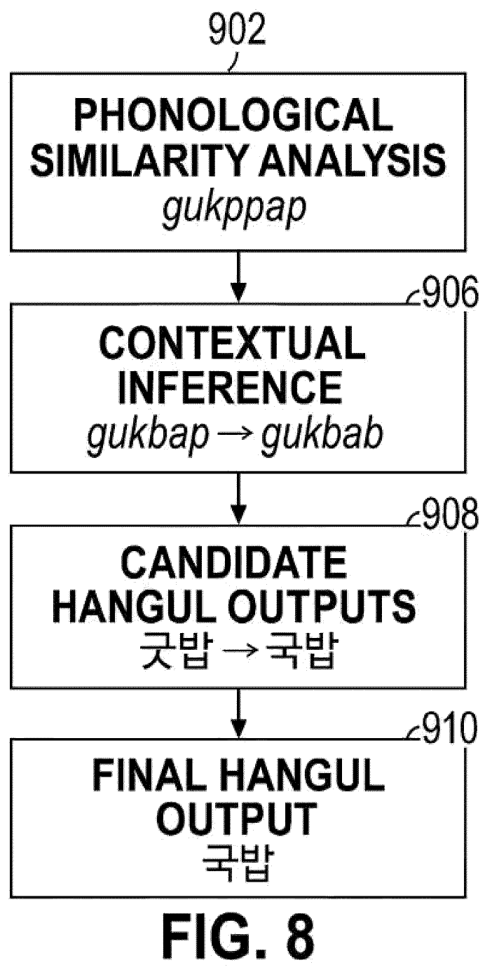

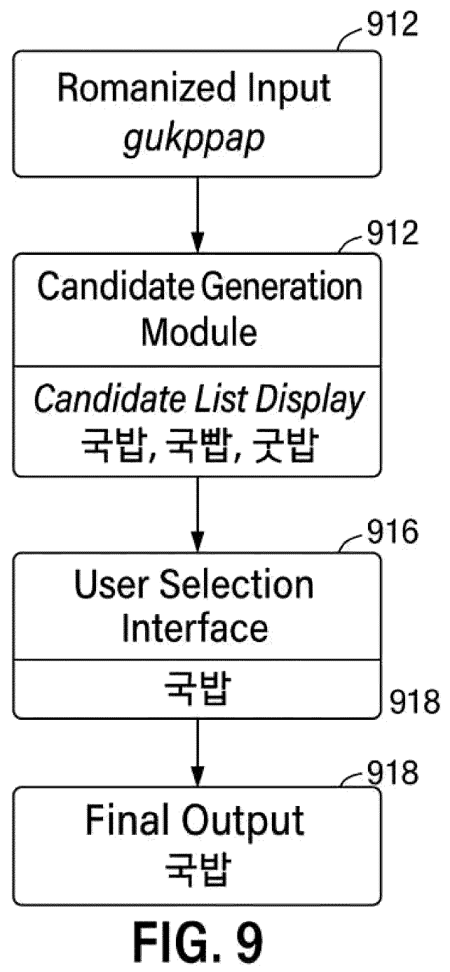

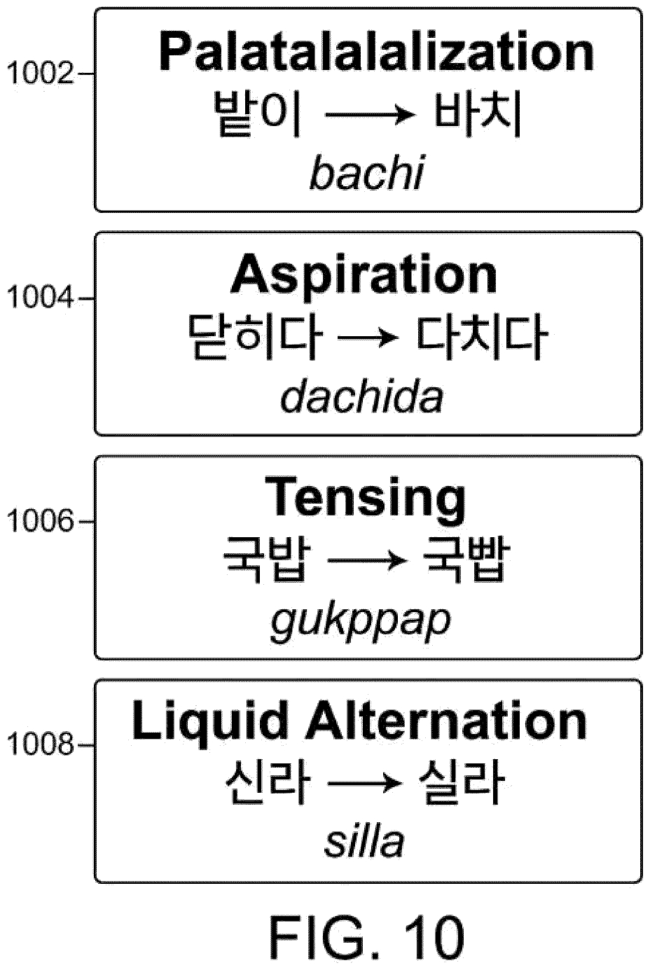

TABLE 1
List of Drawings

| FIG. No. | Title of Drawing |
|---|---|
| FIG. 1 | System Architecture for Romanized Korean Input |
| FIG. 2 | Roman-to-Hangul Processing Pipeline Flowchart |
| FIG. 3 | Real-Time User Interface for Candidate Selection |
| FIG. 4 | Similarity-Based Correction and Neural Ranking Engine |
| FIG. 5 | Contextual Post-Processing with Transformer Model (BERT) |
| FIG. 6 | Edge Case Handling: Slang, Emoticons, Complex Batchim |
| FIG. 7 | Phoneme Mapping Table: Roman ↔ Hangul with IPA |
| FIG. 8 | Ambiguity Resolution Example: “gukppap” Case |
| FIG. 9 | Phonological Rule Engine − Transformations and Candidates |
| FIG. 10 | Batchim-Triggered Transformation Rules and Repository |

### DETAILED DESCRIPTION OF THE INVENTION

FIG. 1—System Architecture

FIG. 1 illustrates the overall system architecture (10) for converting Romanized user input into Korean Hangul characters through a modular, multi-stage processing pipeline.

The architecture comprises seven primary modules, each responsible for a distinct phase of the transformation process, and all integrated within a unified control flow.

The process begins with the Input Acquisition Module (100), which captures Romanized input from various sources such as physical keyboards, touchscreens, or voice-to-text interfaces. Each keystroke is appended to an input buffer (101), which monitors for syllable or word boundaries in real time.

The buffered input is then passed to the Phoneme Mapping and Combination Generator (200). This module references a phoneme mapping database (210) to generate all valid Hangul syllable combinations (212). A Phonological Rule Engine (220) applies linguistic transformations such as nasal assimilation, palatalization, and aspiration.

If no exact match is found, the Similarity Evaluation Module (230) evaluates phonetic similarity using a Longest Common Subsequence (LCS) algorithm (230) and optionally, phonetic embeddings (235). This enables robust handling of informal or erroneous input.

The resulting candidates are passed to the Candidate Ranking Engine (300), which assigns composite scores based on multiple criteria: LCS distance (301), corpus-based frequency (310), contextual fit (320), user behavior history (330), and optional neural similarity vectors (340). The top-ranked candidates (350) are selected for display.

The Query Interface Module (400) presents the ranked candidates (410) in real time. Users confirm selections via selection controls (420), after which the selected Hangul characters (430) are rendered in the output field.

Upon sentence completion, the Contextual Correction Module (500) activates a BERT-based language model (510) to refine grammar, tense, honorifics, and word endings. The final corrected output is rendered as Final Sentence Output (520).

The system may also include Optional Output Extensions (600), such as Text-to-Speech (TTS) output (610), emoticon rendering (620) based on sentiment, and learning feedback (630) for language learners.

This modular architecture enables extensibility, adaptability, and high linguistic accuracy, forming the structural foundation for the operational flows described in FIGS. 2 through 10.

FIG. 2—Input Flow and Processing Pipeline

FIG. 2 illustrates the input flow (20) and the sequential processing pipeline for converting Romanized input into accurate Korean Hangul output. Each stage corresponds to one or more functional modules described in the system architecture of FIG. 1.

The process begins with the Romanized Input Capture stage (100, 101). The user enters Roman characters via an input interface, and the Input Acquisition Module (100) appends each keystroke to an input buffer (101). This buffer continuously monitors for syllable boundaries and triggers downstream processing.

The buffered input is passed to the Phoneme Mapping and Candidate Generation stage (200, 210, 212, 220). A phoneme mapping database (210) is used to generate all valid Hangul syllable combinations (212), accounting for multiple phonetic interpretations of each Roman character. A Phonological Rule Engine (220) applies linguistic rules such as nasal assimilation, palatalization, and aspiration to refine the candidate sequences.

If no exact match is found, the system proceeds to the Similarity Evaluation stage (230, 235). Here, a Longest Common Subsequence (LCS) algorithm (230) and optional phonetic embeddings (235) are used to assess phonetic similarity between the input and known Hangul forms. This enables correction of informal or erroneous input.

The resulting candidates are forwarded to the Candidate Ranking stage (300-350). The Candidate Ranking Engine (300) assigns composite scores based on multiple criteria, including LCS similarity (301), word frequency from corpus data (310), contextual compatibility (320), user behavior memory (330), and optional neural vector similarity (340). The top-ranked candidates are selected and stored in a candidate list (350).

The system then enters the Interactive Confirmation stage (400-430). The Query Interface Module (400) displays the ranked candidates (410) in real time. Users confirm their selection via selection controls (420), such as buttons or keyboard shortcuts. The confirmed Hangul characters (431) are rendered in the composed output field (430).

After a phrase or sentence is completed, the Contextual Sentence-Level Correction stage (500-520) is triggered. The Contextual Correction Module (500) uses a BERT-based language model (510) to refine grammar, tense, honorifics, and sentence structure. The final corrected output is rendered as Final Sentence Output (520).

In extended embodiments, the system may include Optional Output Extensions (600-630). These include Text-to-Speech (TTS) output (610) for accessibility, emoticon rendering (620) based on sentiment analysis, and learning feedback (630) for language learners.

This structured flow ensures that even noisy, irregular, or learner-generated Romanized input can be seamlessly converted into fluent and grammatically accurate Korean text. The pipeline is adaptive, linguistically informed, and tightly integrated with the modular architecture of FIG. 1.

FIG. 3—User Interface of the Romanized Korean Input System

FIG. 3 illustrates the graphical user interface (30) of the Romanized Korean input system, which enables real-time interaction with the user during the text composition process.

The interface is designed to support both casual users and language learners by providing intuitive layout, dynamic feedback, and accessibility features.

At the top of the interface is the Input Field (101), where the user enters Romanized characters. Each keystroke is captured by the Input Acquisition Module (100) and appended to the input buffer for processing.

Directly beneath the input field is the Candidate Suggestion Panel (410), which displays a ranked list of Hangul candidates (411) generated by the Candidate Ranking Engine (300). The list updates dynamically as the user types.

Each candidate (411) is paired with a Selection Control (420), such as a clickable button or touch-sensitive area. The user can confirm a candidate using mouse input, keyboard shortcuts, or touchscreen gestures.

Once a candidate is selected, it is committed to the Composed Output Field (430). This field displays the confirmed Hangul characters (431) and accumulates the ongoing composition. It may optionally support editing or backtracking.

If a candidate involves phonetic substitution, auto-correction, or ambiguous mapping, the system may display Correction Indicators (440). These visual cues-such as underlines, color highlights, or tooltips-help the user understand the system's reasoning.

A Feedback Element (450) allows the user to rate or comment on the quality of suggestions. This feedback is routed to the Candidate Ranking Engine (300) to improve future predictions and personalization.

The interface may also include Optional Accessibility Features (460-463), such as:
Text-to-Speech buttons (461) to vocalize the composed sentence,
Enlarged candidate views (462) for users with visual impairments,
Language mode toggles (463) for bilingual or multilingual environments.

This user interface ensures that the Roman-to-Hangul conversion process remains transparent, adaptive, and user-driven. It complements the modular processing pipeline described in FIGS. 1 and 2 by providing real-time interaction and feedback.

FIG. 4—Similarity-Based Correction and Neural Ranking Engine

FIG. 4 illustrates the operation of the similarity-based correction engine (40), which enables the system to robustly process nonstandard, informal, or phonetically approximate Romanized input and produce accurate Hangul suggestions.

The process begins with the Input Sequence Buffer (101), which stores the Romanized string captured by the Input Acquisition Module (100). This buffer facilitates preprocessing and provides contextual continuity for mapping and correction.

The input buffer is processed by the Phonetic Candidate Generator (212), which belongs to the Combinational Mapping Module (200). It generates a broad range of candidate Hangul sequences by interpreting the input across multiple plausible phonological variations, including homophones, vowel shifts, and consonant substitutions.

The system evaluates each candidate using a Longest Common Subsequence (LCS) Evaluation Unit (230). This unit measures string-level phonetic proximity, accounting for letter omissions, transpositions, or overlaps between the user's input and dictionary entries.

In parallel or optionally, a Phonetic Embedding Engine (235) projects both input strings and candidate sequences into a shared vector space. This embedding model captures learned phonological patterns that extend beyond string similarity, thereby improving correction accuracy.

A Neural Similarity Ranker (340) integrates the results from LCS distance, phonological rule analysis, and phonetic embeddings. It adjusts the scoring logic using personalized heuristics such as prior user selections, usage history, or contextual priors.

The highest-ranked suggestions are compiled into a Ranked Suggestion Output (350). These include standard spellings as well as likely informal forms, and are forwarded to the interface module (400) for display.

When a user confirms or rejects a suggestion, the decision is logged via a Correction Feedback Loop (450). This loop updates the ranking model in real time, allowing the system to learn and adapt based on individual user input patterns and preferences.

Together, these components enable the engine to integrate symbolic matching (LCS), deep learning (embeddings), and real-time feedback to produce resilient, adaptive, and linguistically informed Hangul output—even in the face of noisy or erroneous Romanized input.

FIG. 5—Contextual Post-Processing Module with BERT Integration

FIG. 5 illustrates the Contextual Correction Module (500), which performs sentence-level refinement of user-confirmed Hangul output by leveraging linguistic and contextual cues through a pretrained BERT-based language model.

The process begins with the Initial Composed Sentence (430), which is the accumulated Hangul output generated and confirmed through the Query Interface Module (400). This initial composition serves as the input for post-processing once a full phrase or sentence is detected.

The composed sentence is passed to a Preprocessing and Tokenization Unit (501), which segments the text into morphemes or word-level tokens. These tokens are normalized and encoded to conform to the input schema required by the language model.

The normalized tokens are input into a BERT-Based Language Model (510). This contextual model analyzes both preceding and succeeding words, enabling simultaneous left- and right-contextual assessment. It evaluates: Syntactic structure, Verb agreement and honorific usage, Politeness/formality alignment, Morphological accuracy (e.g., particles, endings), and Semantic coherence.

Based on the BERT model's internal representations, a Grammatical Correction Engine (511) detects and applies appropriate corrections to erroneous or non-standard expressions. For instance:

“ [symbol] ” is corrected to “ [symbol] ”,

Informal-to-formal style shifts may transform “ [symbol] ” into “ [symbol] [symbol] ”

If the input includes ambiguous interpretations (e.g., homophones), a Disambiguation Resolver (512) evaluates the surrounding context to select the most appropriate meaning. Examples include:

“saetbyeol” being interpreted as “ [symbol] ” or “ [symbol] ” depending on sentence context, “dachida” resolving to either “ [symbol] ” or “ [symbol] .”

The fully refined result is delivered to the Final Revised Output field (520). This field holds the grammatically and contextually corrected sentence, which may be presented to the user for confirmation or used for subsequent modules like TTS output.

In enhanced configurations, a Learning Feedback Module (530) collects user reactions to the corrected sentence—such as approvals, re-edits, or overrides—and feeds this data back into the Candidate Ranking Engine (300). This enables adaptive personalization of future outputs.

The module described in FIG. 5 allows the invention to evolve beyond character-level generation by embracing deep semantic correction. It enables high-quality, fluent, and context-sensitive Korean expression, even from noisy or partially ambiguous Romanized inputs.

FIG. 6—Corner Case Handling: Slang, Emoticons, Batchim, and Non-Standard Romanization

FIG. 6 illustrates the corner case processing module (60), which enables robust interpretation and correction of non-standard, informal, or ambiguous Romanized Korean input. This module supplements the core mapping and ranking pipeline by addressing edge cases encountered in casual or phonologically inconsistent user input.

The system first encounters Complex Batchim Combinations (601), such as compound consonant codas like “27”, “20”, or “ [symbol] ”. For example, the user input “balpda” is mapped to “ [symbol] ”. The Phonological Rule Engine (220) processes such input using morphophonemic decomposition logic to correctly reconstruct the underlying Hangul form.

For Slang and Informal Expressions (602), inputs like “jjenda” (intended as “ [symbol] ”) or “meokgo” (“ [symbol] ”) are resolved using a Dynamic Slang Dictionary (603).

This dictionary is continuously updated based on user usage patterns, online corpora, and crowd-sourced vernacular. Informal phrases are prioritized by a usage-based frequency model to match real-world communication trends.

The Emoticon and Onomatopoeia Recognition Module (604) processes Romanized emotive inputs such as “ [symbol] ”, “ [symbol] ”, “keu keu keu”, and “OMG”. A subcomponent, the Pattern Recognition Engine (605), identifies symbolic patterns and maps them to Unicode emojis, stylized Hangul (“ [symbol] ”), or leaves them unaltered, depending on contextual intent and user preferences.

When users input based on Auditory Perception (606)—such as typing “silla” for “ [symbol] ” (phonetic “ [symbol] ”)—the system uses a Phonological Pattern Matcher (606) to interpret the intended word. Ambiguities like “dachida” may be resolved as “ [symbol] ” or “ [symbol] ” through phonotactic parsing and contextual disambiguation using Module 512 from FIG. 5.

All exceptional cases are ultimately passed to the Robust Mapping Engine (607). This engine synthesizes rule-based phoneme matching, probabilistic n-gram modeling, contextual scoring from the BERT Module (510), and user-specific correction patterns captured by the Feedback Module (530). These elements jointly determine the final Hangul output.

This configuration significantly broadens the input tolerance of the system, enabling fluid handling of colloquial, expressive, and creatively Romanized text often found in instant messaging, social platforms, and speech-to-text applications.

FIG. 7—Phoneme Mapping Table: Roman Input to Hangul with IPA and Contextual Variants

FIG. 7 illustrates a Phoneme Mapping Table (701) that defines how Romanized input strings correspond to Hangul characters through phonetic and contextual interpretation. The table supports the Combinational Mapping Module (200) and Candidate Generation Unit (212) described in previous figures.

The table structure (701) is organized into multiple columns:
Hangul Character (701a): the target output grapheme in Korean,
Roman Input Representation (701b): one or more common Romanized spellings,
IPA Notation (701c): the corresponding International Phonetic Alphabet symbol for precise pronunciation,
Contextual Notes and Variants (701d): additional guidance on usage, ambiguity, and regional variation.

A single Roman input may correspond to multiple Hangul outputs, depending on context. For instance:
“k” maps to both “ [symbol] ” and aspirated “ [symbol] ”,
“r” maps to flap [r] (“ [symbol] ”) in initial position and lateral [l] in final position,
“ng” is treated as ø (null consonant) initially and “∘” finally.

The mapping logic includes rules for tense (fortis) and aspirated consonants, where repeated Roman letters such as “tt”, “pp”, “kk” signify tense articulation. For example:
“tt”→“ [symbol] ” [ [symbol] ],
“pp”→“ [symbol] ” [ [symbol] ],
“ch”→“ [symbol] ” [tç^{h}].

Ambiguous vowel representations are also handled in this mapping. For example:
“ae” vs. “e” maps to “ [symbol] ” [ε] and “ [symbol] ” [e],
“oe” vs. “we” to “ [symbol] ” [ø] and “ [symbol] ” [we],
“ui” [ [symbol] ] may be input as “i”, “eui”, or “wi” depending on learner background and phonetic proximity.

To resolve such ambiguity, the system uses Contextual Differentiation Logic (705) that factors in phonotactic position, neighboring characters, and morphosyntactic rules. For example, the mapping of “ [symbol] ” may change depending on whether it reinforces aspiration (“ [symbol] ”→[ [symbol] ]) or becomes silent.

The mapping table is dynamically linked to the Phonological Rule Engine (220) for rule-based refinement and the Contextual Correction Module (500) via the BERT model (510) for semantic disambiguation. These references allow the system to adjust output based on usage history and sentence-level coherence.

Representative mappings shown in FIG. 7 include:
“kkam”→“ [symbol] ” via tense “ [symbol] ” [ [symbol] ],
“nyeong”→“ [symbol] ” built from “n+yeo+ng”,
“silla”→“ [symbol] ” resolved as “ [symbol] ” through historical phonology overrides.

A full list of mappings, including consonant and vowel variants, IPA symbols, and contextual usage notes, is provided in Table 1, which complements the structure summarized in FIG. 7.

This mapping mechanism ensures flexible recognition of input from formal users, language learners, and informal communicators alike—enhancing the system's robustness across domains and dialects.

TABLE 2
Mapping of Romanized Letters to Multiple Hangul Consonants and
Vowels for Flexible Input Recognition (See FIG. 7)

| Hangul | Roman Input | IPA | Notes/Variants |
|---|---|---|---|
| [symbol] | g, k | [k], [g] | Initial: [k]; Final: [symbol] ; ambiguous with [symbol] (k) |
| [symbol] | kk, gg | [symbol] ] | Tense consonant |
| [symbol] | n | [n] | — |
| ⊏ | d, t | [t], [d] | Initial: [t]; Final: [symbol] ; overlaps with E |
| [symbol] | tt, dd | [t] | Tense consonant |
| [symbol] | r, l | [r], [l] | Initial: tap [r]; Final: [l] |
| [symbol] | m | [m] | — |
| [symbol] | b, p | [p], [b] | Initial: [p]; Final: [symbol] ; overlaps with [symbol] |
| [symbol] | pp, bb | [ [symbol] ] | Tense consonant |
| [symbol] | s | [s] | — |
| [symbol] | ss | [ [symbol] ] | Tense consonant |
| O | ″, ng | [n], Ø | Initial: null (silent); Final: [n] |
| [symbol] | j | [t [symbol] ] | Confused with ch |
| [symbol] | jj | [t [symbol] ] | Tense consonant |
| [symbol] | ch | [t [symbol] ^{h}] | Aspirated |
| [symbol] | k | [k^{h}] | Aspirated; confused with [symbol] |
| E | t | [t^{h}] | Aspirated; overlaps with ⊏ |
| [symbol] | p | [p^{h}] | Aspirated; overlaps with [symbol] |
| [symbol] | h | [h] | — |
| [symbol] | a | [a] | — |
| [symbol] | ae | [ε] | Often confused with [symbol] (e) |
| [symbol] | ya | [ja] | — |
| [symbol] | yae | [jε] | Often confused with [symbol] (ye) |
| [symbol] | eo | [Λ] | Often mistyped as u or o |
| [symbol] | e | [e] | Overlaps phonetically with ae |
| [symbol] | yeo | [jΛ] | — |
| [symbol] | ye | [je] | Close to yae |
| [symbol] | o | [o] | — |
| [symbol] | wa | [wa] | Decomposable: [symbol] + [symbol] |
| [symbol] | wae | [wε] | Decomposable: [symbol] + [symbol] |
| [symbol] | oe | [ø] | Often confused with wae, we |
| [symbol] | yo | [jo] | — |
| [symbol] | u | [u] | Sometimes input as wu |
| [symbol] | wo | [wΛ] | Decomposable: [symbol] + [symbol] |
| [symbol] | we | [we] | Confused with wae |
| [symbol] | wi | [wi] | — |
| [symbol] | yu | [ju] | — |
| — | eu | [w] | No English equivalent |
| [symbol] | ui | [ [symbol] ], [wi] | Confused with i, eui |
| \| | i | [i] | — |

Table 2 corresponds to the Phoneme Mapping Table (701) described in FIG. 7, and serves as a core reference for candidate generation and ambiguity resolution in the system.

FIG. 8—Ambiguity in Official Romanization and Disambiguation Strategies

FIG. 8 illustrates the system's approach to resolving ambiguity caused by unofficial or incorrect Romanized Korean input, using the example of “gukppap.” This scenario reflects real-world user behavior deviating from the official Romanization guidelines issued by the Ministry of Culture, Sports and Tourism (MCST).

The Romanized input “gukppap” is received by the system and evaluated by the Phonological Similarity Analysis Module (902). This module examines patterns such as consonant duplication (“pp”) and phonotactic anomalies that often arise in casual typing environments, mapping plausible alternates like “gukbap”.

The output candidates from phonological evaluation are passed to the Contextual Inference Module (906), which uses prior user input, adjacent words, and semantic probabilities to determine the most contextually appropriate Hangul candidates. This is supported by semantic modeling via Module 510 in FIG. 5.

Multiple candidate Hangul forms are produced and ranked through the Candidate Output Generator (908). In this case, the options might include:
“ [symbol] ” (phonetically plausible but semantically unlikely),
“ [symbol] ” (spelling variant with tense consonant),
“ [symbol] ” (semantically and phonetically plausible in context).

Based on contextual confidence scores, frequency rankings, and optionally user feedback, the system selects a final output via Module 910, yielding “ [symbol] ” as the corrected Hangul result.

While FIG. 8 focuses on a single user input example, the ambiguity resolution framework extends to a wide range of Romanized strings where multiple Hangul interpretations are possible. More general cases—such as “ui”, “gye”, or “ye”—are covered structurally in FIG. 9 and associated matrix-based mappings.

This process demonstrates the system's ability to handle errors and informalities in Romanized Korean input by combining phonological similarity, contextual modeling, and candidate ranking, thus bridging the gap between user behavior and standard orthographic conventions.

FIG. 9—Phonological Rules and Transformation Handling

FIG. 9 illustrates a phonological transformation module (90) that enables the system to interpret Romanized input reflecting spoken Korean rather than strict orthographic rules. These rules enhance recognition accuracy, especially in informal, auditory-based typing scenarios.

The Phonological Rule Engine (220) receives Romanized input such as “gukppap” and dynamically applies relevant transformation patterns prior to candidate ranking and contextual correction.

The engine evaluates phonological rules that include:
Nasal Assimilation: e.g., “Jongno” typed as [tçηno] rather than “ [symbol] ”→“ [symbol] ”.

Palatalization: e.g., “ti”→“ [symbol] ”, as in “ [symbol] ” pronounced [ [symbol] ].

Aspiration: e.g., “ [symbol] ”→[ [symbol] ] (joko), triggered by suffix “ [symbol] ”.

Consonant Insertion/Elision: e.g.,” [symbol] ”→[ [symbol] ], processed as “Hangnyeoul”.

Tense Consonant Reduction: e.g., “ [symbol] ” (saetbyeol), where fortis consonants soften in rapid speech.

These patterns are encoded as rule entries (906a) within the system and assigned confidence weights (906b). Each transformation contributes weighted signals to the final candidate scoring model.

As shown in the example, input “gukppap” is transformed through:
Phonological Similarity Analysis (902): Interpreting “pp” as an overemphasized or duplicated input of “b”.
Contextual Inference (906): Using preceding/following words or tokens to predict likely correction.
Candidate Generation (908): Including “ [symbol] ”, “ [symbol] ”, “ [symbol] ” as possible outputs.
Final Output Selection (910): “ [symbol] ” is chosen as the most probable correction based on context and feedback.

These rule-driven disambiguation steps are integrated with the Candidate Ranking Engine (300) and Contextual Correction Module (500), and may optionally surface alternatives to the user via the User Interface Module (400) for active confirmation.

This layered phonological processing bridges the gap between canonical spelling and real-world usage, allowing the system to accept diverse and expressive Roman input forms while producing accurate Korean outputs.

FIG. 10—Batchim-Triggered Phonological Transformations

FIG. 10 illustrates the batchim-triggered phonological transformation module (100) that enables the system to interpret non-standard Romanized Korean input influenced by final consonants in Hangul syllables. These transformations bridge the gap between written forms and spoken realization in casual or auditory-based inputs.

The transformation module is managed by the Phonological Rule Engine (220) in conjunction with the Context-Aware Post-Processing Module (500). Together, they identify and apply rule-based conversions triggered specifically by batchim consonants.

As shown in block 1002, the batchim “E” or “⊏” preceding the vowel “|” (i) induces palatalization. For example:
“ [symbol] ” is processed as “ [symbol] ” ([ba.tç^{h}i])→“bachi”,
“ [symbol] ” becomes “ [symbol] ” ([ga.tç^{h}i])→“gachi”.

In block 1004, aspiration is triggered by batchim stops followed by suffixes. For instance:

“ [symbol] ” may be input as “dachida” and resolved as either “ [symbol] ” or “ [symbol] ” based on semantic context, such as whether the subject is animate (“ [symbol] ”) or inanimate (“ [symbol] ”).

Block 1006 depicts tensing (fortition) that occurs after cluster-final batchim. Rapid or emphatic pronunciation may lead users to type:

“gukppap” instead of “gukbap”, reflecting the perception of a tense “ [symbol] ”. The system preserves and resolves such tensing cues within Candidate Generator (212) and Ranking Engine (300).

Block 1008 highlights liquid alternation, where the consonant “ [symbol] ” shifts based on position:
“ [symbol] ” ([∫il.la]) may be typed as “silla”, reflecting a palatalized initial,
“ [symbol] ” may require semantic disambiguation, with “ [symbol] ” or “ [symbol] ” resolved through BERT-based modeling (Module 510).

In more complex expressions (not shown in figure), rules such as compound transformations apply:
e.g., “ [symbol] ”→[ [symbol] ] (“meongneun”), combining nasal assimilation+lenition,
or “ [symbol] ”→[ [symbol] ] (“anja”), merging batchim with glide vowel.

These transformations are formally stored in a Phonological Rule Repository (1006), with each rule including:
Trigger Condition (1006a) such as batchim-vowel boundary,
Transformation Output (1006b) like modified IPA or candidate,
Context Weight (1006c) from usage data and model inference.

Once triggered, the rules feed into:
Candidate Ranking Module (300) for evaluation,
Contextual Correction (500) for validation,
And optionally into the User Interface (400) for feedback-enhanced confirmation.

For example, when a user enters “bachida,” the system evaluates it as:
Literal “ [symbol] ” (a field is . . . ), or
More likely “ [symbol] ” (to offer), based on subject-verb compatibility and real-world usage frequency.

Through these rule-based transformations, the system ensures accurate interpretation of user input that reflects pronunciation rather than orthographic fidelity-enhancing robustness and usability for informal, dialectal, or learner-driven Romanized Korean inputs.

TABLE 3
Summary of Batchim-Triggered Phonological Transformation Rules
(See FIG. 10)

| Rule | Example | Transformed | |
|---|---|---|---|
| Type | Input | Output | Explanation |
| Palatalization | bachi | [symbol] | Batchim “E/⊏” + “ \| ” triggers |
| | | | palatalization: ti → [symbol] |
| Aspiration | dachida | [symbol] | Batchim “L” followed |
| | | [symbol] | by aspirated |
| | | | suffix; disambiguated |
| | | | by subject context |
| Tensing | gukppap | [symbol] | Emphatic or rapid speech |
| (Fortition) | | | causes perception of tense |
| | | | consonant “ [symbol] ” |
| Liquid | silla | [symbol] | = assimilated or changed |
| Alternation | | | due to position and |
| | | | neighboring vowels |
| Compound | anja | [symbol] | Batchim “ [symbol] ” + “ [symbol] ” |
| Rule | | | yields glide |
| | | | transformation |
| Nasal | meongneun | [symbol] | [symbol] + [symbol] assimilated to |
| Assimilation | | | [nn] in spoken form |

[Note]
These rules are encoded in the Phonological Rule Repository (1006) and triggered dynamically by the Rule Engine (220), as described in FIG. 10 and paragraphs [0120]-[0130].

TABLE 4
Claim-to-FIG Correlation Table

| | Relevant | Associated Functional Components |
|---|---|---|
| Claim No. | FIG(s) | and Processes |
| 1 | FIG. 1, FIG. 2, | System architecture and |
| (Independent) | FIG. 3, FIG. 4, | processing pipeline |
| | FIG. 5 | including modules (100-500) |
| 2 | FIG. 5 | Contextual correction |
| | | using BERT-based |
| | | NLP module (500, 510, 511) |
| 3 | FIG. 3 | Real-time user interface for dynamic |
| | | candidate display and selection |
| | | (410, 420, 430) |
| 4 | FIG. 6 | Detection and handling of |
| | | slang, emotional expressions, |
| | | and emoticons (602, 604, 605) |
| 5 | FIG. 6, | Processing of complex batchim |
| | FIG. 10 | consonant clusters (601, 1001-1005) |
| 6 | FIG. 4 | Candidate scoring and ranking |
| | | using LCS and similarity |
| | | embeddings (230, 235, 340) |
| 7 | FIG. 3, FIG. 4 | User interaction feedback loop |
| | | for adaptive learning (450, 530) |
| 8 | FIG. 2, FIG. 5 | Ambiguity resolution |
| | | using combinational |
| | | mapping and semantic scoring |
| | | (212, 301, 510) |
| 9 | FIG. 8 | Handling of ambiguous Romanized |
| | | sequences such as “ui” (801-805) |
| 10 | FIG. 9 | Phonological transformation handling |
| | | including nasal assimilation, |
| | | palatalization, and aspiration |
| | | (901-907) |
| 11 | FIG. 10 | Context-driven batchim transformation |
| | | handling (1001-1007) |
| 12 (Method) | FIG. 2, FIG. 3, | End-to-end flow from Roman input |
| | FIG. 4, FIG. 5 | to Hangul composition and |
| | | sentence refinement |
| 13 (Computer- | FIG. 1-FIG. 5 | Software implementation |
| Readable | | of core functional |
| Medium) | | modules and processing steps |

1. An electronic apparatus for converting Romanized Korean input into corresponding Hangul characters, the apparatus comprising: a memory configured to (i) store a phoneme mapping database comprising rules associating Romanized letter sequences with Korean phonemes and graphemes, including multiple candidates derived from combinational, contextual, and phonological variants; and (ii) store a repository of phonological transformation rules triggered by batchim (final consonants) and morphophonemic environments; and a processor operably coupled to the memory and configured to (i) receive a Romanized letter input sequence from a user; (ii) identify one or more candidate Hangul outputs by (a) performing direct mapping using the phoneme database and (b) applying phonological transformation rules including nasal assimilation, palatalization, aspiration, tensing, and batchim-triggered alternation; (iii) rank the candidates based on similarity scores, contextual probability, user history, and semantic fit, including computing a similarity metric using a Longest Common Subsequence (LCS) algorithm; (iv) present the ranked candidates to the user via a query interface that updates dynamically in response to incremental input; (v) receive user selection or confirmation; (vi) compose the selected candidate into output text; and (vii) refine the resulting sentence using a context-aware language model to improve grammaticality, coherence, and stylistic accuracy, the language model comprising a transformer-based neural network such as BERT.

2. The apparatus of claim 1, wherein the phonological transformation rules include batchim-driven processes comprising palatalization, including transforming “ [symbol] ” to “ [symbol] ”; aspiration, including transforming “ [symbol] ” to “ [symbol] ”; and tensing, including transforming “ [symbol] ” to “ [symbol] ”.

3. The apparatus of claim 1, wherein the language model comprises a transformer-based neural network configured to correct tense, formality, part-of-speech agreement, and semantic anomalies in the composed output.

4. The apparatus of claim 1, wherein the processor is configured to dynamically detect ambiguous Romanized sequences including “ui”, “gye”, or “oe”, and resolve them using contextual scoring algorithms and user interaction feedback.

5. The apparatus of claim 1, wherein the ranking engine is configured to assign weights to each candidate based on similarity distance, phoneme overlap, historical selection frequency, and predicted semantic compatibility.

6. The apparatus of claim 1, wherein the query interface is configured to enable real-time updates to candidate suggestions as each Roman letter is typed.

7. The apparatus of claim 1, further comprising a user adaptation module configured to record user interaction patterns and adjust future output preferences based on reinforcement learning.

8. The apparatus of claim 1, wherein the phoneme mapping database is configured to include edge-case structures such as complex batchim clusters including “27”, “20”, and “ [symbol] ”, along with their corresponding morphotactic disambiguation logic.

9. The apparatus of claim 1, wherein the processor is configured to support multi-syllabic parsing of continuous Romanized input strings without space delimiters and to infer word boundaries using prosodic cues and contextual modeling.

10. The apparatus of claim 1, wherein the processor is configured to detect informal, expressive, or mimetic inputs and to provide filtered candidate outputs or emoticon-enhanced forms.

11. The apparatus of claim 1, wherein the transformation rules are encoded as weighted pattern-action pairs and are dynamically updated based on system feedback and language model inference.

12. A method implemented by the apparatus of claim 1, the method comprising: receiving a Romanized input sequence from a user; retrieving phoneme candidates from a mapping database including pronunciation variants; applying rule-based phonological transformations including batchim-triggered palatalization, aspiration, and assimilation; generating a ranked candidate list using scoring metrics based on similarity, frequency, and context; presenting the ranked list to the user via a real-time interface and receiving a candidate selection; composing the selected Hangul text; analyzing the composed sentence using a context-aware language model to ensure grammaticality and semantic validity; and updating the candidate scoring model based on user selection history and usage patterns.

13. A non-transitory computer-readable storage medium storing instructions that, when executed by one or more processors, cause the processors to perform the method of claim 12, the method comprising: receiving a Romanized input string from a user; matching the input against phoneme and phonological mapping rules stored in memory; generating Hangul candidates using similarity algorithms and transformation logic; ranking the candidates by contextual fit, frequency, and user-specific behavior; displaying the candidates via a real-time user interface; processing user selection and composing Hangul output; and refining the composed sentence using a transformer-based language model and updating internal weights based on user feedback.
